(19) United States
(12) Patent Application Publication
(10) Pub. No.: US 2026/0318496 A1
(43) Pub. Date: Oct. 15, 2026

(54) VEHICULAR MODULAR LUMINAIRES

(71) Applicant: Federal Signal Corporation, Downers Grove, IL (US)

(72) Inventors: Jeffery M. Loftus, Tinley Park, IL (US); George R. Frank, Crown Point, IN (US); Paul M. Gergets, St. John, IN (US)

(21) Appl. No.: 19/344,850

(22) Filed: Sep. 30, 2025

Related U.S. Application Data
(60) Provisional application No. 63/785,926, filed on Apr. 9, 2025.

(51) Int. Cl. F21S 43/15; F21S 2/00; F21S 43/14; F21S 43/19; F21S 43/31; F21V 7/00; F21V 21/005; F21V 29/70; F21V 31/04; F21Y 103/10; F21Y 113/17; F21Y 115/10

(52) U.S. Cl. CPC F21S 43/15; F21S 2/005; F21S 43/14; F21S 43/195; F21S 43/31; F21V 7/0083; F21V 21/005; F21V 29/70; F21V 31/04; F21Y 2103/10; F21Y 2113/17; F21Y 2115/10

(57) ABSTRACT

An example light system can include: a housing defining an interior cavity; a circuit board disposed within the interior cavity; a plurality of light sources mounted on the circuit board; an optical assembly positioned adjacent to the plurality of light sources; an optically-permissive compound substantially filling the interior cavity of the housing, wherein the optically-permissive compound has an index of refraction similar to polycarbonate; and at least one injection port formed in the housing for receiving the optically-permissive compound.

### BACKGROUND

Vehicle light systems have traditionally relied on fragile and heavy components that are difficult to install and maintain. These conventional systems can suffer harsh environmental conditions, particularly in lower vehicle locations where exposure to moisture, debris, and mechanical shock is common. Significant challenges remain in developing robust, efficient, and customizable lighting solutions that can provide consistent illumination while being protected from environmental factors.

### SUMMARY

Examples provided herein are directed to a modular luminaire.

According to one aspect, an example light system can include: a housing defining an interior cavity; a circuit board disposed within the interior cavity; a plurality of light sources mounted on the circuit board; an optical assembly positioned adjacent to the plurality of light sources; an optically-permissive compound substantially filling the interior cavity of the housing, wherein the optically-permissive compound has an index of refraction similar to polycarbonate; and at least one injection port formed in the housing for receiving the optically-permissive compound.

According to another aspect, a vehicle includes: a running board; and a light system mounted below the running board, the light system including: a housing defining an interior cavity; a circuit board disposed within the interior cavity; a plurality of light sources mounted on the circuit board; an optical assembly positioned adjacent to the plurality of light sources; an optically-permissive compound substantially filling the interior cavity of the housing, wherein the optically-permissive compound has an index of refraction similar to polycarbonate; and at least one injection port formed in the housing for receiving the optically-permissive compound.

According to another aspect, method for assembly a light system, includes: mounting light emitting diode (LED) boards to a circuit board; positioning the LED boards and the circuit board in a housing; injecting optically-permissive potting compound into the housing through at least one injection port defined by the housing such that LEDs of the LED boards are encapsulated in the optically-permissive potting compound; allowing the optically-permissive potting compound to cure in the housing; and sealing opposite ends of the housing.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example modular light system having two connected modules.

FIG. 2 shows another view of the example light system of FIG. 1.

FIG. 3 shows a cross-sectional view of example internal components of one of the modules of the system of FIG. 1.

FIG. 4 shows an example extrusion of the light system of FIG. 1.

FIG. 5 shows an example end cap of the light system of FIG. 1.

FIG. 6 shows an example plastic housing of the light system of FIG. 1.

FIG. 7 shows an exploded view of the plastic housing of FIG. 6.

FIG. 8 shows ends of adjacent plastic housings of the light system of FIG. 1.

FIG. 9 shows a rear view of the plastic housing of the light system of FIG. 1.

FIG. 10 shows an example circuit board and optics of the light system of FIG. 1.

FIG. 11 shows another rear view of the plastic housing of the light system of FIG. 1.

FIG. 12 shows a cross-sectional view of a portion of the plastic housing of FIG. 11.

FIG. 13 shows another cross-sectional view of the plastic housing of FIG. 11.

FIG. 14 shows another cross-sectional view of the plastic housing of FIG. 11.

FIG. 15 shows additional details of the plastic housing of FIG. 11.

FIG. 16 shows an example method for manufacturing the light system of FIG. 1.

### DETAILED DESCRIPTION

The disclosure relates to a modular luminaire with a customizable length that can be attached below a vehicle running board. The luminaire includes multiple elongated modules connected end-to-end. Each module can contain light emitting diode (“LED”) light sources mounted on a circuit board that provides electrical power, with the housing filled with an optically clear potting material that enhances waterproofing and toughness. The potting material is similar to or has substantially the same refractive index of polycarbonate to eliminate the need for refractive optics, allowing the use of offset reflectors for light control without external refractive elements that can be affected by dirt and debris. The modules can be connected in series with multiple modules being controlled by a single controller, featuring LED arrays configurable with different colors and patterns for warning signals, perimeter lighting, and vehicle identification. Key features include an optically-permissive compound that fills the housing cavity, dovetail structures for connecting modules, and an extrusion on all four sides of the housing.

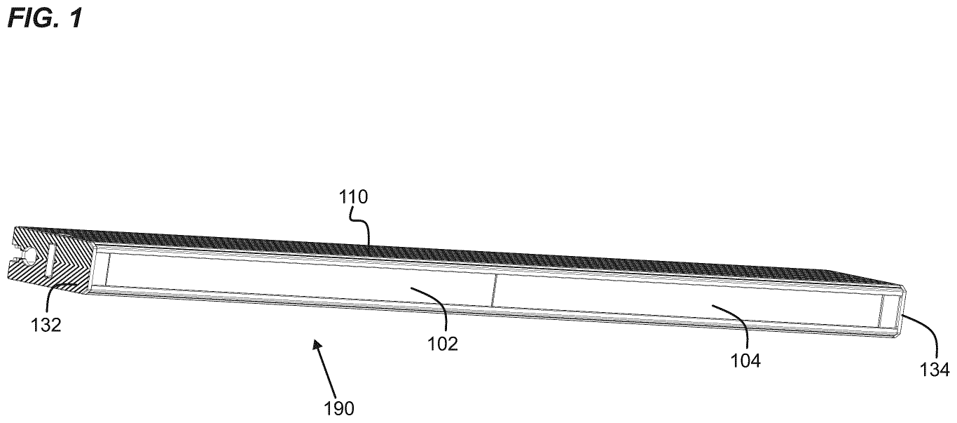

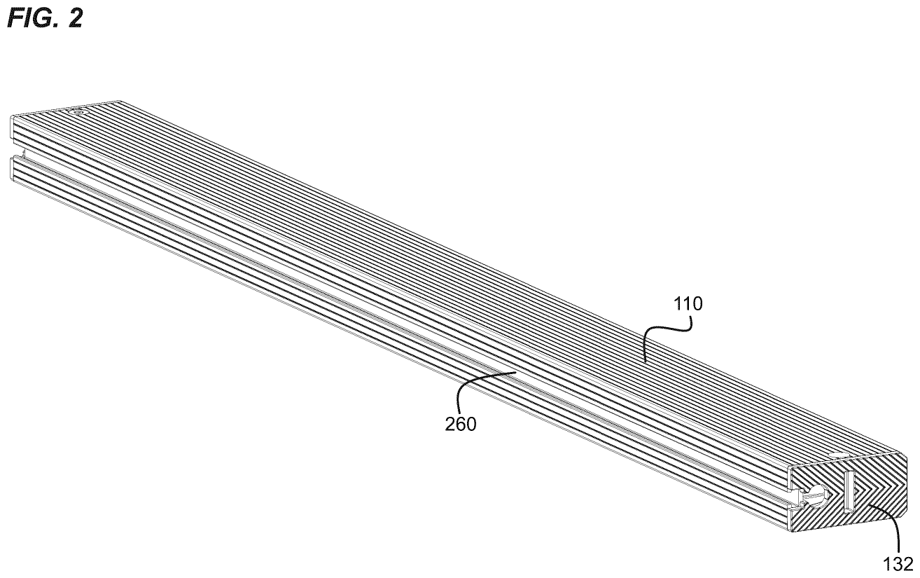

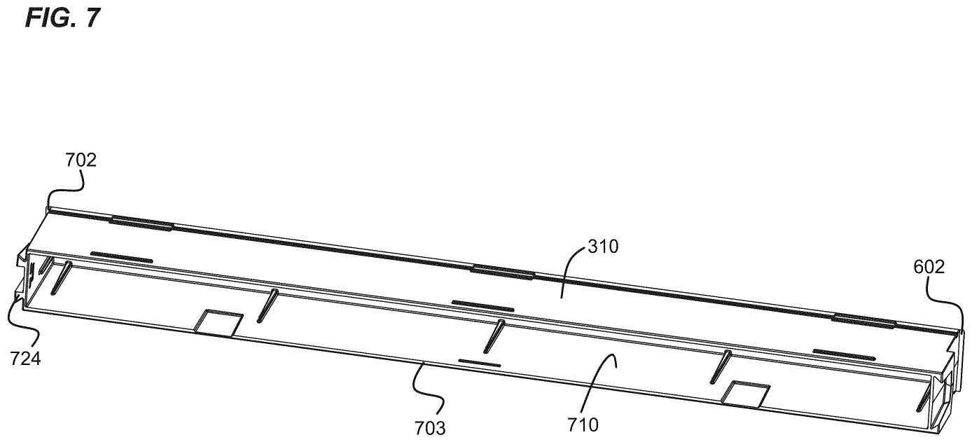

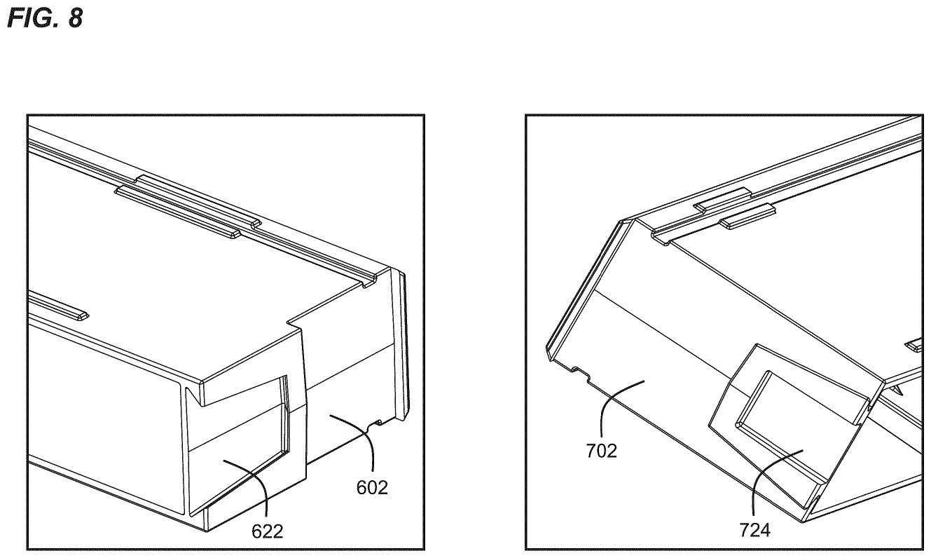

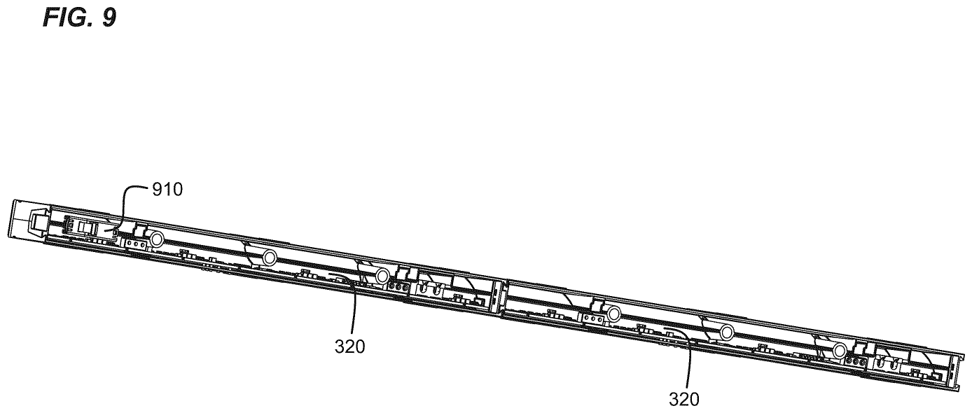

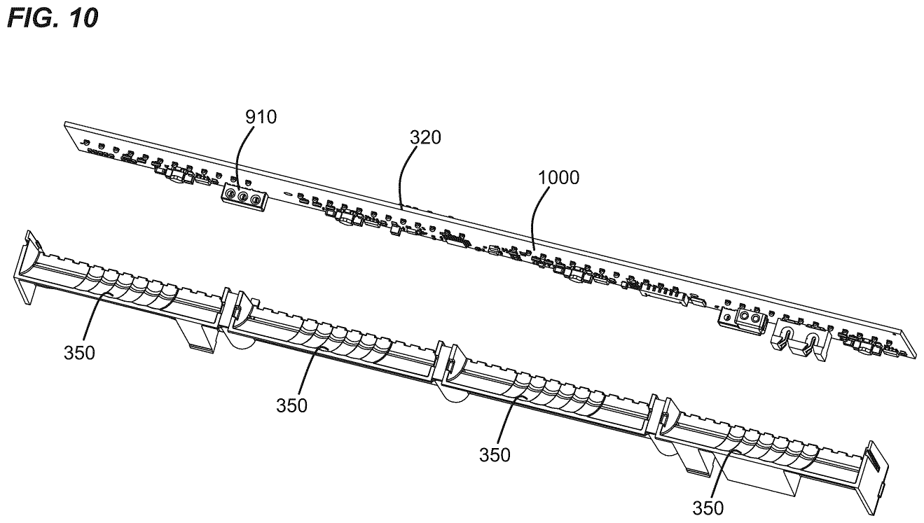

FIGS. 1-10 show aspects of an example modular light system 100 that can be mounted to a vehicle. For example, the light system 100 can be mounted adjacent to a running board. The modularity allows the length of the light system 100 to be customized to a particular vehicle or to a location of a vehicle where the light system 100 is to be mounted. In the depicted example, the modular light system 100 includes two of the modules 102, 104. Additional modules can be added in series based on the same principles described herein for connecting two modules together, as described herein.

Referring to FIGS. 1-3, each of the example modules 102, 104 includes a one-piece molded plastic housing 310 formed using various molding techniques, such as injection molding. The housing 310 can be formed with an open rear end 703 having an interior 710 that houses LED light sources 352, which are included in the electronics 320. The electronics 320 can include a circuit board 1000 upon which the electrical components of the light system 100 are mounted.

Each module 102, 104 also includes optics 350 with one or more internal reflectors for collimating and adjusting light beams that are generated by the LED light sources 352 and wiring and electronics 320 for providing power and control signals to the LED light sources 352. Wiring between the modules 102, 104 is routed through rear openings in each of the housings 310, and waterproof four-pin connectors 910 are used to couple each module 102 to the next module 104.

The modules 102, 104 can be connected in series, with any suitable number of modules (e.g., 1, 2, 3, 4, 5 or more modules) controlled by a single controller. The modules 102, 104, including the LED light sources 352, can be configured with different colors and patterns for various functions including warning signals, perimeter lighting, and vehicle identification.

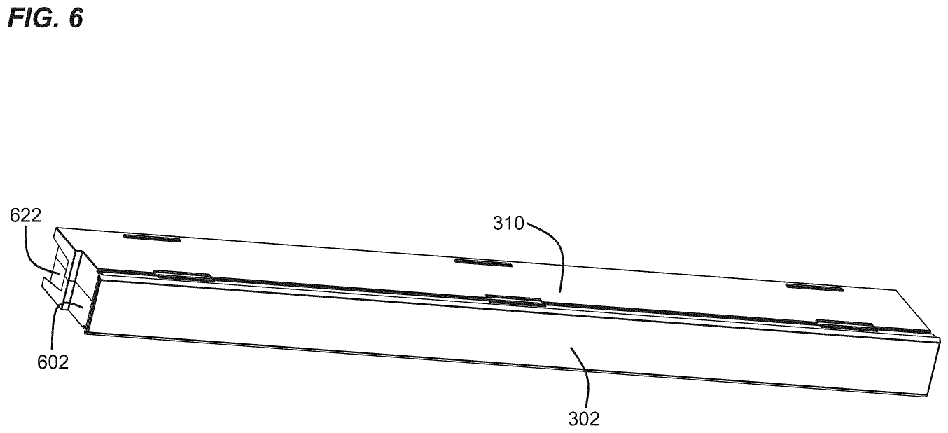

To connect the two modules 102, 104 together in series, complementary dovetail mating features 622, 724 on opposing ends 602, 702 of the two module housings 102, 104 are mated to each other, as shown in FIGS. 6-8.

More specifically, the dovetail mating features 622, 724 are integrated into the housing 310 that extends along all four sides. When modules 102, 104 are connected, the complementary dovetail mating features 622, 724 interlock to join the modules 102, 104 together.

Then, an extrusion 110, formed by extruding a material such as aluminum, that has been cut to length, is slid over the modules 102, 104 that are being connected. To secure the extrusion 110 to the module housings 310, the extrusion 110 has opposing top and bottom ribs 372, 374 that slidingly mate with complementary top and bottom grooves 376, 378 defined by the housings 310.

The extrusion 110 also includes overhang portions 382, 384 that hang over a front side 190 of the housings 310 above and below an optical lens 302 through which the light beam emanates. These overhang portions 382, 384 are positioned to hang over the optical lens 302 at both the top and bottom of the front side 190. The overhang portions 382, 384 work in conjunction with opposing top and bottom ribs 372, 374 that slidingly mate with complementary top and bottom grooves 376, 378 defined by the housings 310. This structural arrangement provides both mechanical protection for the optical lens and secure mounting of the extrusion 110 to the housing 310.

The extrusion 110 extends along all four sides of the housing 310 and includes these protective overhang portions 382, 384 as part of its integrated design. When modules are connected in series, the extrusion 110 spans across multiple modules while maintaining consistent overhang protection along the entire assembly length of the light system 100.

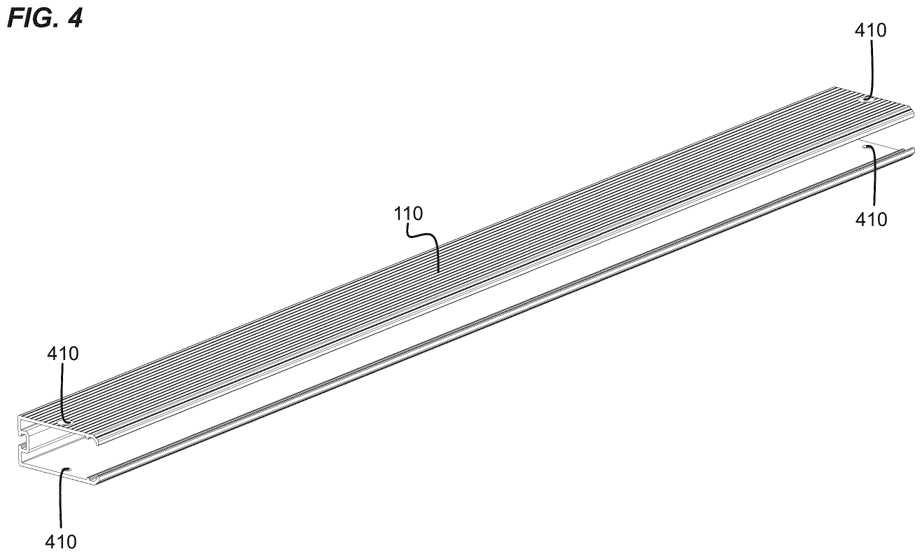

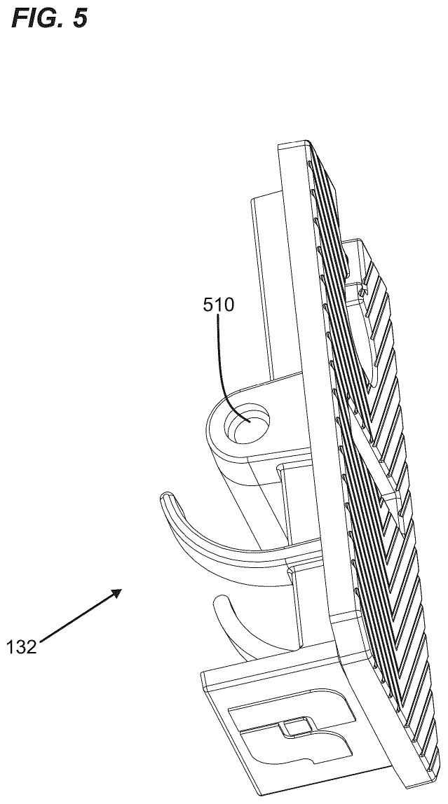

In addition, end caps 132, 134 are placed on opposing ends of the assembled light system 100. A total of two end caps 132, 134 can be used regardless of the number of connected modules. Screws or other fasteners are inserted through holes 410 in the extrusion and holes 510 in the end caps 132, 134 to secure the extrusion 110 to the end caps 132, 134 and thereby also prevent longitudinal sliding of the extrusion 110 relative to the modules 102, 104. See FIGS. 4-5.

At the rear of the light system 100, the extrusion 110 has a longitudinal groove 260 with a T-shaped cross-section. Heads of fasteners, such as screws, bolts, nails, etc., can be mounted in the T-shaped groove 260 to fasten the light system to a vehicle, e.g., beneath a running board of approximately corresponding length.

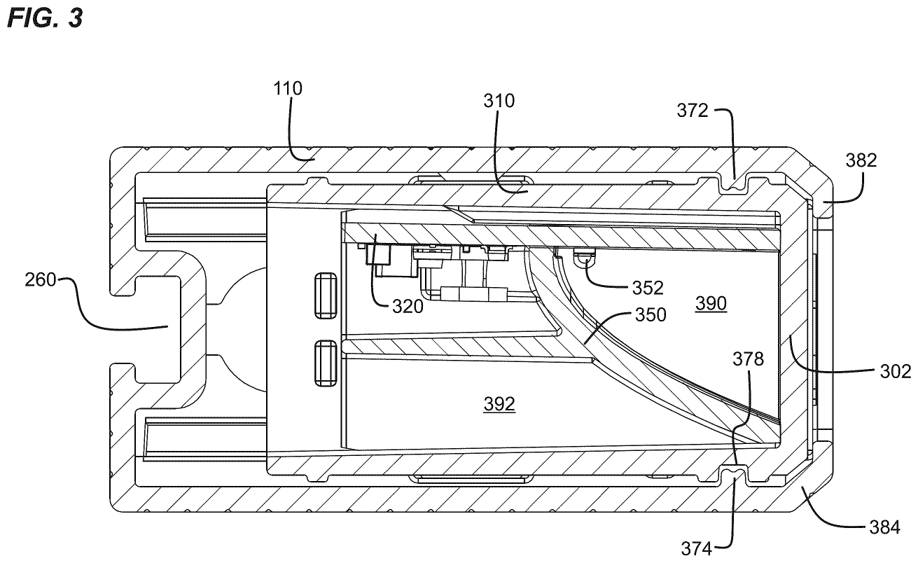

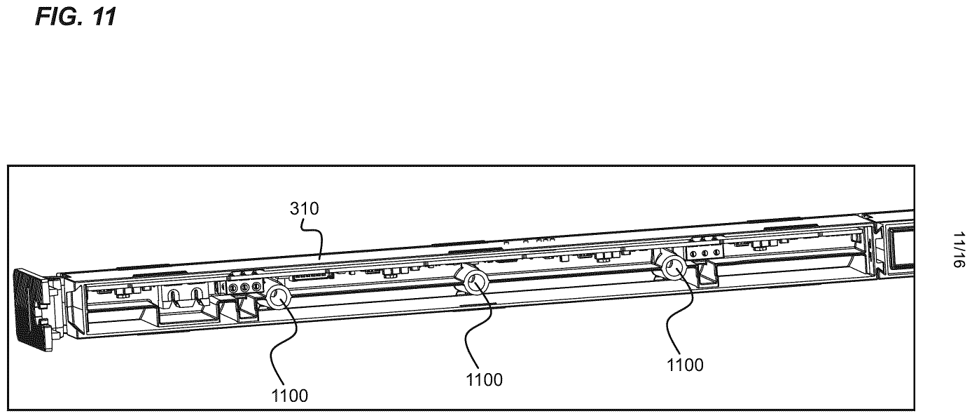

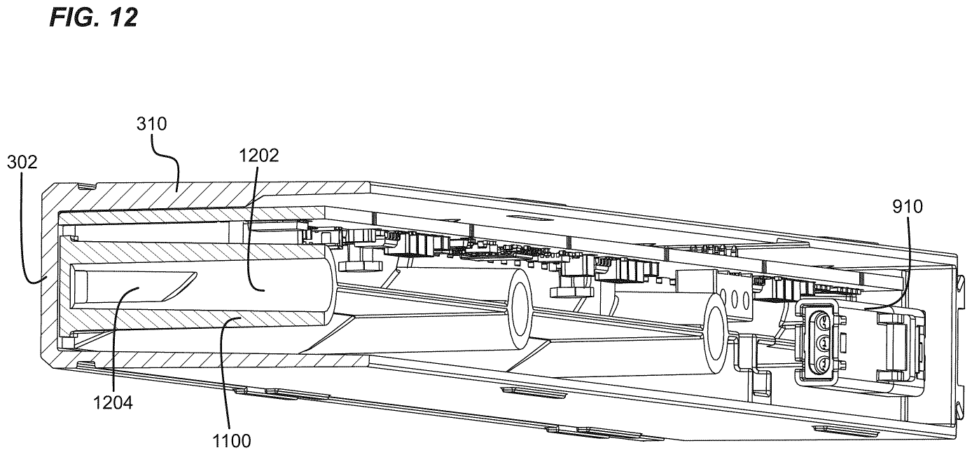

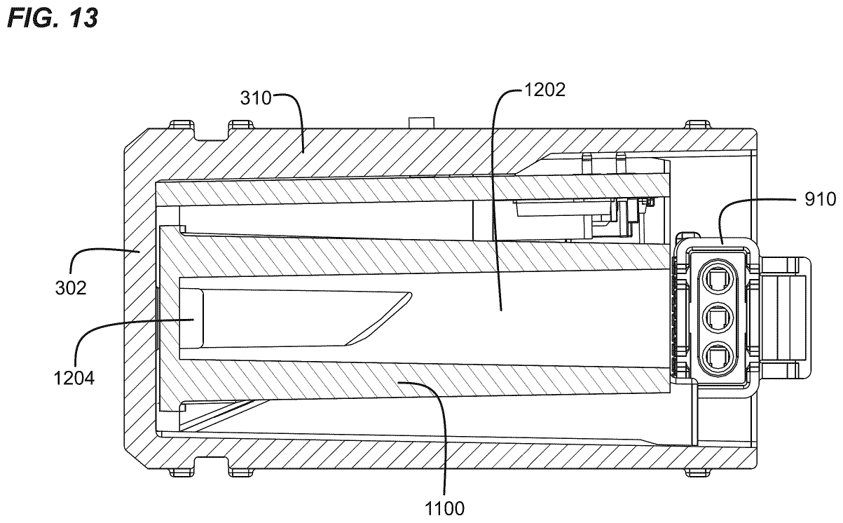

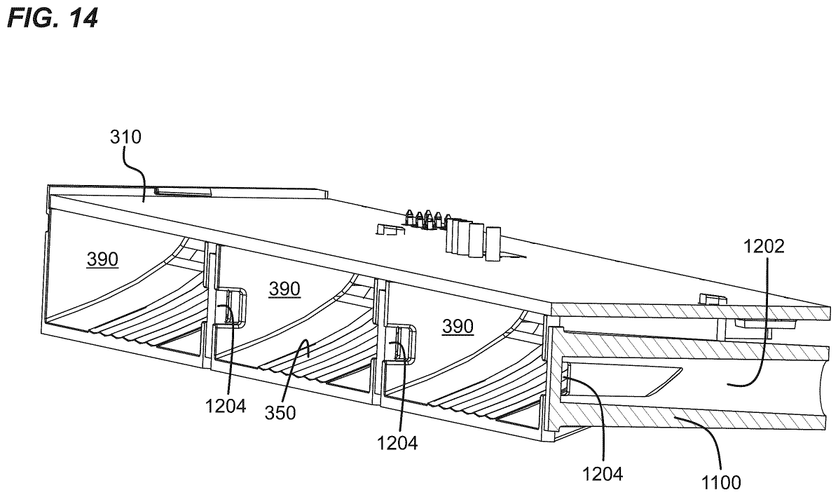

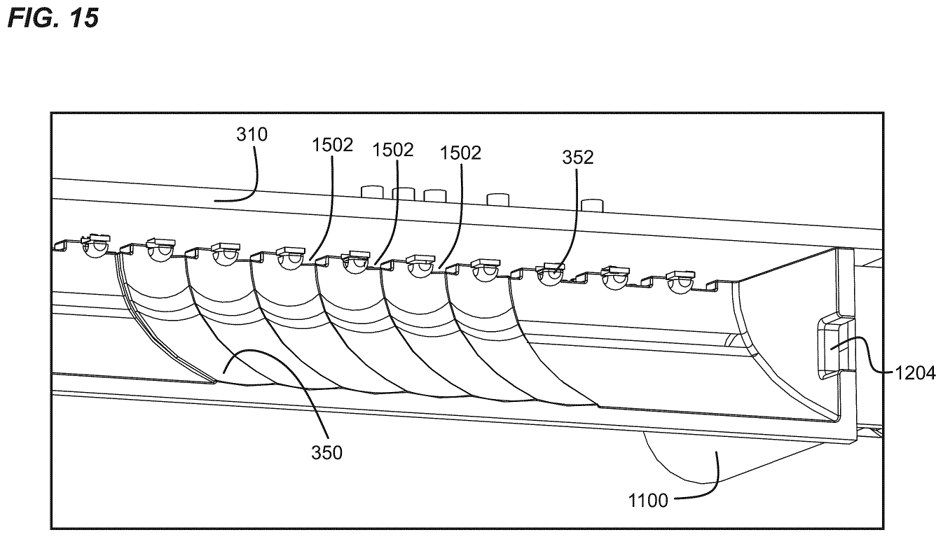

Referring now to FIGS. 3 and 11-15, in some examples, an interior of the light system 100 is filled with an optically clear potting gel compound.

Generally, the compound possesses an index of refraction nearing polycarbonate (e.g., between 1.3 to 1.7, more preferably approximately 1.59) to minimize or eliminate the need for refractive optics, while being capable of transitioning from an initial viscous state to a rubber-like composition after curing. In one embodiment, the compound is DOWSIL EI-2888 primerless encapsulant from Dow Chemical, although other materials can be used.

This compound can fill a substantial entirety of the internal volume of the light system 100, including both the front and back portions. It can be injected through ports, with one port per light-head. The potting compound can have an index of refraction that matches polycarbonate, which minimizes or eliminates the need for additional refractive elements.

In its cured state, the compound provides multiple benefits including mechanical support and shock protection for the LED components, enhanced structural strength, protection against moisture ingress, and improved heat dissipation from the LED sources. The optical properties of the compound can be modified through the addition of various materials.

When fully cured, the compound provides protection for both the LED light emitters and associated electronics while maintaining optimal optical performance of the luminaire and each light-head within the luminaire.

The compound can provide multiple benefits, including structural strength enhancement, moisture protection, and heat dissipation. The compound is designed to be viscous or semi-fluid during manufacture and transforms to a composition of substantially greater viscosity after manufacture.

In the example shown, the component can fill spaces 390 and 392 of the molded plastic housing 310. The compound is injected through a port 1100 provided for each light-head. The port 1100 defines a hollow interior 1202 that extends through the housing 310 to an opening 1204 formed in the port 1100.

When forced through the interior 1202 of the port 1100 to the opening 1204, the compound enters and fills the space 390. This protects the LED light sources 352. Further, the compound is forced from the space 390 through saw-toothed holes 1502 formed in the optics 350 to the space 392. The compound fills the space 392 to protect the electronics 320.

Many alternatives are possible. For instance, the compound can be injected using various methods, such as injection and/or suction techniques.

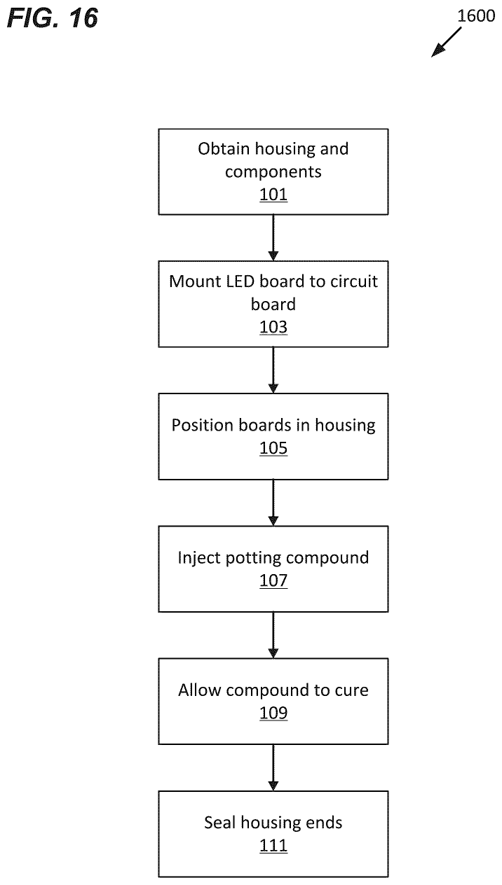

Referring now to FIG. 16, an example method 1600 for manufacturing the light system 100 is shown.

Initially, step 101 includes obtaining the number of needed molded housings, circuit boards, LED light sources, and end caps. The housing includes features for mounting the components and ports for injecting the potting compound, as described herein.

Next at step 103, the LED board is mounted against the inside surface of the optical assembly, e.g., using screws or other fasteners.

At step 105, the assembled LED and circuit board components are positioned within the housing cavity.

Next, at step 107, the optically-permissive compound is injected into the housing. The compound fills all internal volume of the light module through dedicated ports. The potting material flows into both front and back portions through saw-tooth features, filling spaces around the LEDs and circuit board. The compound has an index of refraction matching polycarbonate to eliminate need for refractive optics.

At step 109, the potting compound cures. During curing, the compound maintains optical clarity. The cured compound enhances structural strength, provides moisture protection, and facilitates heat dissipation.

Finally, at step 111, end caps are secured to provide closure at either end of the elongated housing.

Many other configurations and methods are possible.

Generally, the electrical components disclosed herein, such as the electronics 320, can include one or more computing devices. Each computing device can include at least one central processing unit (“CPU”) and computer-readable data storage media including a system memory. The system memory includes a random access memory (“RAM”) and a read-only memory (“ROM”). The system memory stores software instructions and data. The system memory is connected to the CPU. The system memory provides non-volatile, non-transitory storage for each computing device. Computer-readable data storage media can be any available non-transitory, physical device or article of manufacture from which the central display station can read data and/or instructions.

The computer-readable data storage media of each computing device can store software instructions and data, including an operating system suitable for controlling the computing device. The computer-readable data storage media also store software instructions and software applications that, when executed by the CPU, cause each computing device to provide the functionality discussed herein.

Although various embodiments are described herein, those of ordinary skill in the art will understand that many modifications may be made thereto within the scope of the present disclosure. Accordingly, it is not intended that the scope of the disclosure in any way be limited by the examples provided.

1. A light system, comprising:
a housing defining an interior cavity;
a circuit board disposed within the interior cavity;
a plurality of light sources mounted on the circuit board;
an optical assembly positioned adjacent to the plurality of light sources;
an optically-permissive compound substantially filling the interior cavity of the housing, wherein the optically-permissive compound has an index of refraction similar to polycarbonate; and
at least one injection port formed in the housing for receiving the optically-permissive compound.

2. The light system of claim 1, wherein the housing is molded.

3. The light system of claim 1, wherein the optical assembly includes at least one internal reflector for collimating light from the plurality of light sources.

4. The light system of claim 1, wherein the optically-permissive compound transitions from an initial viscous state to a rubber-like composition upon curing and conducts heat from the plurality of light sources.

5. The light system of claim 1, further comprising complementary dovetail mating features formed on opposing ends of the housing for connecting to additional housings in series.

6. The light system of claim 1, further comprising an extrusion extending along sides of the housing, the extrusion including opposing top and bottom ribs that mate with complementary grooves defined by the housing.

7. The light system of claim 6, wherein the extrusion further includes:
overhang portions that extend beyond a front side of the housing above and below the optical assembly; and
a mounting groove formed on a rear side.

8. The light system of claim 7, wherein the mounting groove is T-shaped in cross-section.

9. The light system of claim 8, wherein the mounting groove is configured to receive heads of fasteners to fasten the light system to a vehicle.

10. The light system of claim 1, wherein the at least one injection port defines a hollow interior that extends through the housing to an opening, and wherein the optically-permissive compound is forced through the hollow interior to fill a first space around the plurality of light sources.

11. The light system of claim 10, wherein the optically-permissive compound further then flows through holes to fill a second space around the circuit board.

12. The light system of claim 11, wherein the holes define a saw-toothed structure formed in the optical assembly.

13. The light system of claim 1, wherein the at least one injection port comprises a plurality of injection ports, with one port provided for each light-head section of the housing, and wherein each of the plurality of injection ports is configured to receive the optically-permissive compound.

14. The light system of claim 1, wherein the housing includes four light head sections.

15. The light system of claim 14, wherein the circuit board is configured to supply power to each of the four light head sections.

16. The light system of claim 14, wherein the housing includes a total of three injection ports for injecting the optically-permissive compound into the four light head sections.

17. The light system of claim 1, wherein there is no external refractive element mounted to the housing for refracting light emitted by the plurality of light sources.

18. A vehicle, comprising:
a running board; and
a light system mounted below the running board, the light system including:
a housing defining an interior cavity;
a circuit board disposed within the interior cavity;
a plurality of light sources mounted on the circuit board;
an optical assembly positioned adjacent to the plurality of light sources;
an optically-permissive compound substantially filling the interior cavity of the housing, wherein the optically-permissive compound has an index of refraction similar to polycarbonate; and
at least one injection port formed in the housing for receiving the optically-permissive compound.

19. The vehicle of claim 18,
wherein the light system includes:
complementary dovetail mating features formed on opposing ends of the housing for connecting to additional housings in series;
an extrusion extending along sides of the housing, the extrusion including opposing top and bottom ribs that mate with complementary grooves defined by the housing, the extrusion including overhang portions that extend beyond a front side of the housing above and below the optical assembly and a mounting groove formed on a rear side, the mounting groove is T-shaped in cross-section; and
wherein the vehicle includes fasteners having heads positioned in the mounting groove and securing the light system to a body of the vehicle.

20. A method for assembling a light system, comprising:
mounting light emitting diode (LED) boards to a circuit board;
positioning the LED boards and the circuit board in a housing;
injecting optically-permissive potting compound into the housing through at least one injection port defined by the housing such that LEDs of the LED boards are encapsulated in the optically-permissive potting compound;
allowing the optically-permissive potting compound to cure in the housing; and
sealing opposite ends of the housing.
